(19) United States
(12) Patent Application Publication
(10) Pub. No.: US 2014/0173408 A1
(43) Pub. Date: Jun. 19, 2014

(54) IDENTITY BASED AUTOMATED FORM FILLING

(71) Applicants: Etienne Canaud, Shanghai (CN); Jianfeng Ye, Shanghai (CN); Santang Rong, Shanghai (CN)

(72) Inventors: Etienne Canaud, Shanghai (CN); Jianfeng Ye, Shanghai (CN); Santang Rong, Shanghai (CN)

(21) Appl. No.: 14/127,205

(22) PCT Filed: Jun. 24, 2011
(86) PCT No.: PCT/CN2011/001047

§ 371 Date: Dec. 18, 2013

(51) Int. Cl. G06F 17/24

(52) U.S. Cl. CPC G06F 17/243
USPC 715/226

(57) ABSTRACT

An identity based automated form filling method includes maintaining an association of a user, a form, and a plurality of values recorded over time for a plurality of fields of the form. Following a request for the form by the user, the form is caused to be dynamically populated according to the association.

### BACKGROUND

People utilize computers to populate electronic forms for wide variety of tasks. In a business environment, forms are completed for expense reporting, project management, and untold other tasks. Often the tasks are repetitive. If a form could be designed for the particular user, it could be pre-populated by default with the repeating entries. However, applications using such forms are designed for a wide variety of users in a wide variety of roles. As a consequence, pre-populating forms with default entries is often not a viable option as it would only serve the interests of one user.

### DRAWINGS

FIG. 1 depicts an environment in which various embodiments may be implemented.

FIG. 2 depicts a system according to an embodiment.

FIGS. 3 and 4 depict examples of fill data according to embodiments.

FIG. 5 is a block diagram depicting a computer readable medium according to an embodiment

FIG. 6 is a block diagram depicting an implementation of the system of FIG. 2.

FIGS. 7-8 are flow diagrams depicting steps taken to implement embodiments.

FIGS. 9-11 depict examples of dynamically populated forms according to embodiments.

### DETAILED DESCRIPTION

### Introduction

Various embodiments described below were developed in an effort to provide identity based automated form filling. An implementation includes maintaining an association of a user, a form, and a plurality of values recorded over time for a plurality of fields of the form. Such can be accomplished by recording field values selected by the user as the user repeatedly submits the form. Once the association is established, the form is caused to be dynamically populated according to the association following a request for the form by the user.

To cause the form to be dynamically populated, the association can be employed to define a pre-fill model and communicate that model to a service acting in response to a request from the user for the form. The pre-fill model is a configuration data used by the service to dynamically populate the form. A given pre-fill model may be associated with one user and one form. As will be described below, the model can include a fill value for a form field, a candidate value for a form field, as well as linkage data between two fields within the form. The service uses the pre-fill model to dynamically populate a form requested by the user. The service, for example, may be part of an application from which the form was requested or a proxy service between the application and the user.

The following description is broken into sections. The first, labeled “Environment,” describes an exemplary environment in which various embodiments may be implemented. The second section, labeled “Components,” describes examples of various physical and logical components for implementing various embodiments. The third section, labeled as “Operation,” describes steps taken to implement various embodiments.

### Environment

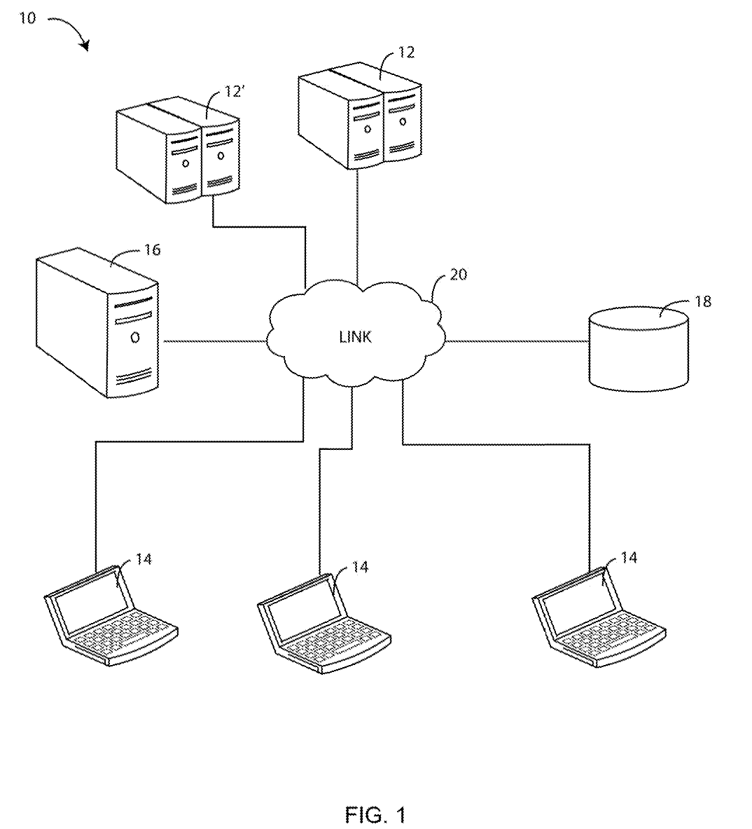

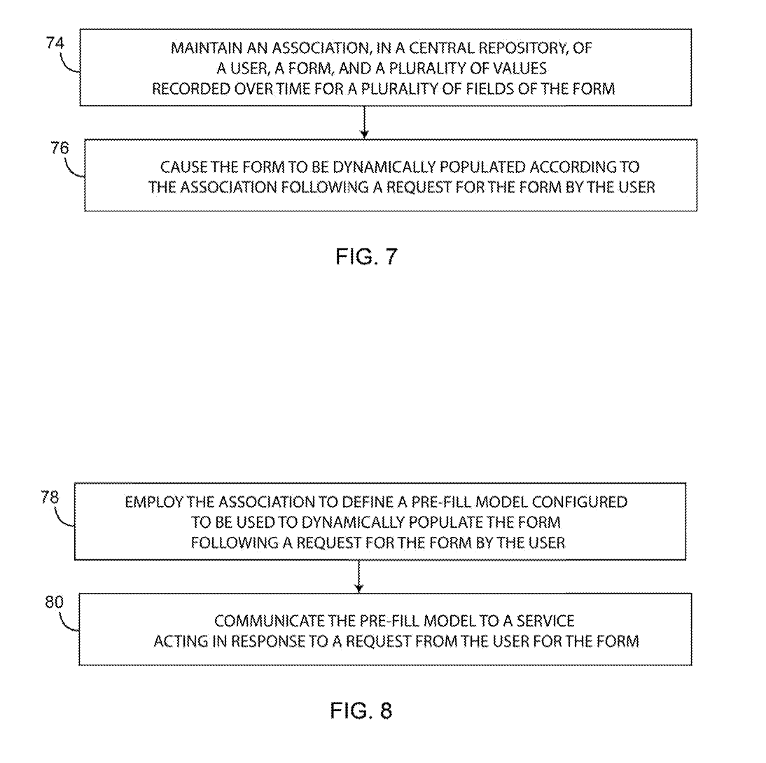

FIG. 1 depicts an environment 10 in which various embodiments may be implemented. Environment 10 is shown to include application device 12, client devices 14, form fill device 16, and data store 18 connected via link 20. Application device 12 represents generally any computing device or combination of computing devices configured to serve an application to client devices 14. When serving the application, application device 12 provides client devices 14 with forms as request. A term form as used herein is an electronic form containing one or more user accessible controls through which a user can select a value when the form is displayed. Selecting a value can be accomplished through any interaction with the form. For example, a value can be selected by entering the value in a text box, selecting the value from a list, or even activating a radio button or checkbox. FIGS. 8-10 depict an example of a form being displayed.

Client devices 14 each represent a computing device configured to interact with application device 12 via link 20. That interaction can include requesting forms on behalf of a user, displaying retrieved forms, and submitting values selected by a user for fields of the displayed forms.

Form fill device 16 represents a computing device configured to provide identity based automated form filling for an application served by application device 12. Data store 18 represents generally any memory configured to store data that can be accessed by form fill device in the performance of its functions. As will be described in more detail below, those functions may include maintaining, in data store 18, an association of a user, a form, and a plurality of values recorded over time for a plurality of fields of the form. Such can be accomplished by recording field values selected by the user over time in data store 18 as the user repeatedly submits the form. Once the association is established, form fill device 16 causes the form to be dynamically populated according to the association following a request for the form by the user.

Application device 12 may provide form fill device 16 with the data needed to establish the association and may receive data from form fill device 16 that it can use to dynamically populate a given form for a given user. Alternatively, environment 10 may include a proxy 12′ that performs such functions. In other words, the proxy intercept a form being returned to a client device 14 for a user and dynamically populate that form according to the association of the user, the form, and the recorded values for the fields of that form. The proxy may also be responsible for providing form fill device 16 with the data needed to maintain associations between users, forms and recorded field values. To summarize, either application device 12 or a proxy 12′ provides a service that acts in response to a request from a user for a form to dynamically populate the form. Form fill device 16 causes this to happen be communicating necessary data to that service. In an example described below, that data is identified as a pre-fill model.

Link 20 represents generally one or more of a cable, wireless, fiber optic, or remote connections via a telecommunication link, an infrared link, a radio frequency link, or any other connectors or systems that provide electronic communication. Link 20 may include, at least in part, an intranet, the Internet, or a combination of both. Link 20 may also include intermediate proxies, routers, switches, load balancers, and the like.

### Components

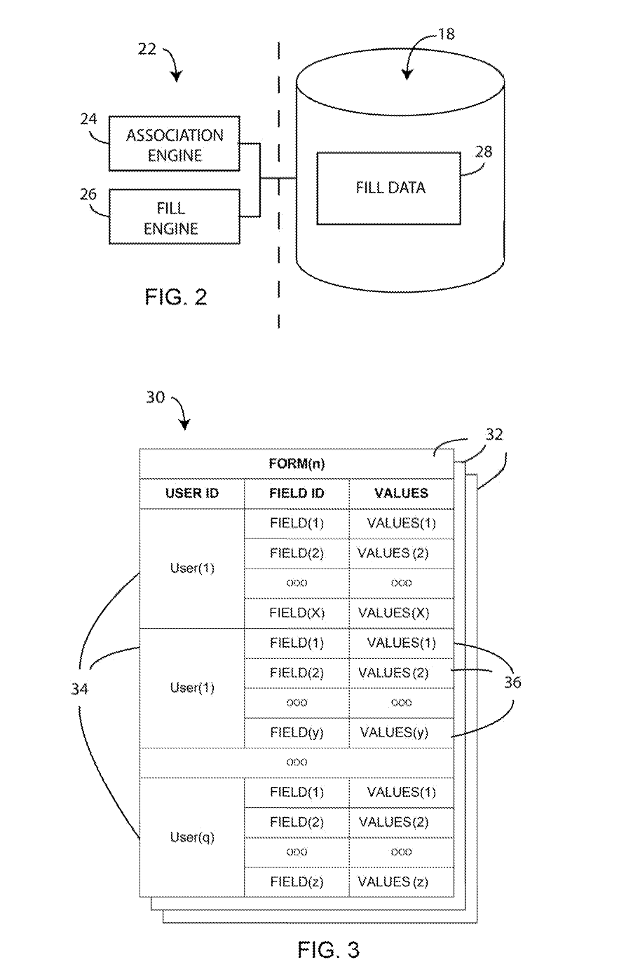

FIGS. 2-6 depict examples of physical and logical components for implementing various embodiments. FIG. 2 depicts system 22 for identity based automated form filling. In the example of FIG. 2, system 22 includes association engine 24 and fill engine 26. Association engine 24 represents generally any combination of hardware and programming configured to maintain an association of a user, a form, and a plurality of values recorded over time for a plurality of fields of the form. Association engine 24 may perform this task by recording, for each of a plurality of fields of the form, values selected by the user for that field over repeated submissions of the form. The values may be recorded in data store 18 as part of fill data 28. As noted above, association engine 24 may obtain the data needed to maintain an association from the application serving the form or from a proxy.

Looking ahead to FIG. 3, data 30 represents an example of an association of each of a plurality of users to a form and to a plurality of values recorded over time for that form. As noted, data 30 may be stored in data store 18 as part of fill data 28. In the example of FIG. 2, data 30 includes a series of tables 32 each dedicated to a given form. The top table 32 is dedicated to form(n) and includes a series of entries 34. Each entry 34 includes values for fields of the form recorded over time from submissions of the form by the corresponding user. Data 30 may only contain a predetermined number of the most recent values for each field or it may contain values recorded during a recent time frame such as the last month or quarter. In this example, association engine 30 performs its function by creating and maintaining data 30.

Referring again to FIG. 2, fill engine 26 represents generally any combination of hardware and programming configured to cause a form to be dynamically populated according to the an association maintained by association engine following a request for the form by the user. Fill engine 26 may perform its function by communicating data to a service responsible for populating a form requested by a user. That service may be supplied by an application that serves the form or a proxy as noted above. The service then uses the communicated data to dynamically populate the form requested by the user.

Fill engine 26 may cause a form to be dynamically populated by employing an association maintained by association engine 24 define a pre-fill model and then communicate that pre-fill model to the service noted above. The particular association employed is the association between the form, the user requested, and the values receded over time for the various fields of the form. A pre-fill model is configuration data associated with a particular form and a particular user. The model includes can include data identifying a fill value for one or more fields of the particular form. The model can include data identifying one or more candidate values to suggest for a particular field of the form. The candidate values may be ordered or prioritized based on a corresponding association. The association will identify how often the user populates a field with the same value. The candidate value having been used the most often will have the highest priority. That is, it will be used first in a list of candidate values. The model can also include data linking to fields of the form. Such data can identify a source field and target field and first and second values. Such target data indicates that when the source field is populated with the first value by the user or otherwise, the target field is to be automatically filled with the second value or that the second value is to be suggested for use in populating the target field. Pre-fill models may be stored as part of fill data 28 to be reused and updated. Thus where a pre-fill model exists, defining the model can include accessing it from data store 18 and, if appropriate, updating the model based on a new or updated association.

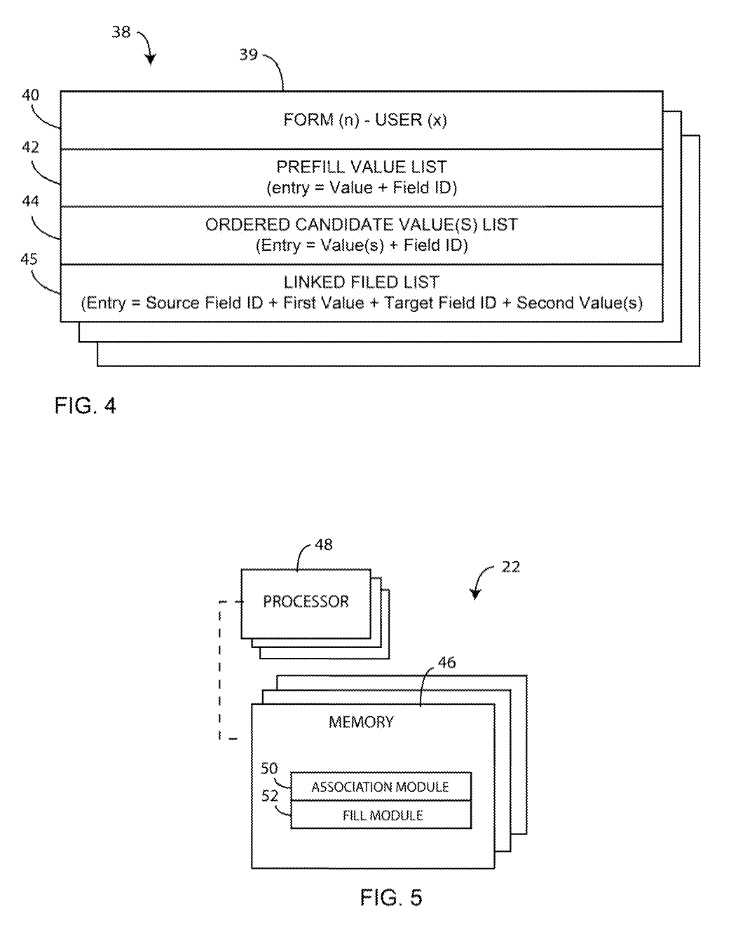

Looking ahead to FIG. 4, data 38 represents pre-fill models 39. As noted, each pre-fill model 39 represents configuration data associated with a particular form and a particular user, As depicted, the top pre-fill model 39 is for form(n)/user(x) as indicated by data 40 and includes data in one or more of lists 42, 44, and 45. List 42 is a list of pre-fill values. If populated, each entry in list 42, for example can include a value paired with a particular field ID of form (n). A field ID identifies a particular field of a given form. If populated, each entry in list 44 can include one or more ordered values (candidate values) paired with a particular field ID of form (n). If populated, each entry in list 45 contains a source field ID, a first value, a target field ID, and a second value or values. Thus an entry in list 45 can be used to populate a field identified by the target field ID with the second value or with second values as candidates when the field identified by the source field ID is populated with the first value.

In defining a pre-fill model 39, fill engine 26 may examine association data to determine if a particular value has been recorded more than a threshold percentage of the time with respect to a given field. If so, the pre-fill list 42 will include an entry that identifies that field and that value as a fill value. If not, but the value and perhaps other values have been used to populate the field more than a lower second threshold percentage, then that value or values may be included in an entry of ordered candidate value list 44. Note that the values can be ordered based on how often each has been used within a given time period. For example, a given value may have been used less than another but more often in a more recent time frame. Thus, that value may have a higher priority. likewise, list 25 is populated with an entry when where fill engine 26 identifies a link between the target field and a source field where upon entry of a first value in the source field results in the given target field being populated with a given value or values.

In foregoing discussion, various components were described as combinations of hardware and programming. Such components may be implemented in a number of fashions. Looking at FIG. 5 the programming may be processor executable instructions stored on tangible memory media 46 and the hardware may include a processor 48 for executing those instructions. Memory 46 can be said to store program instructions that when executed by processor 48 implement system 22 of FIG. 2. Memory 46 may be integrated in the same device as processor 48 or it may be separate but accessible to that device and processor 48.

In one example, the program instructions can be part of an installation package that can be executed by processor 48 to implement system 22. In this case, memory 46 may be a portable medium such as a CD, DVD, or flash drive or a memory maintained by a server from which the installation package can be downloaded and installed. In another example, the program instructions may be part of an application or applications already installed. Here, memory 46 can include integrated memory such as a hard drive.

In FIG. 5, the executable program instructions stored in memory 46 are depicted as association module 50 and fill module 52. Association module 50 represents program instructions that when executed cause the implementation of association engine 24 of FIG. 2. Likewise, fill module 52 represents program instructions that when executed cause the implementation of fill engine 26.

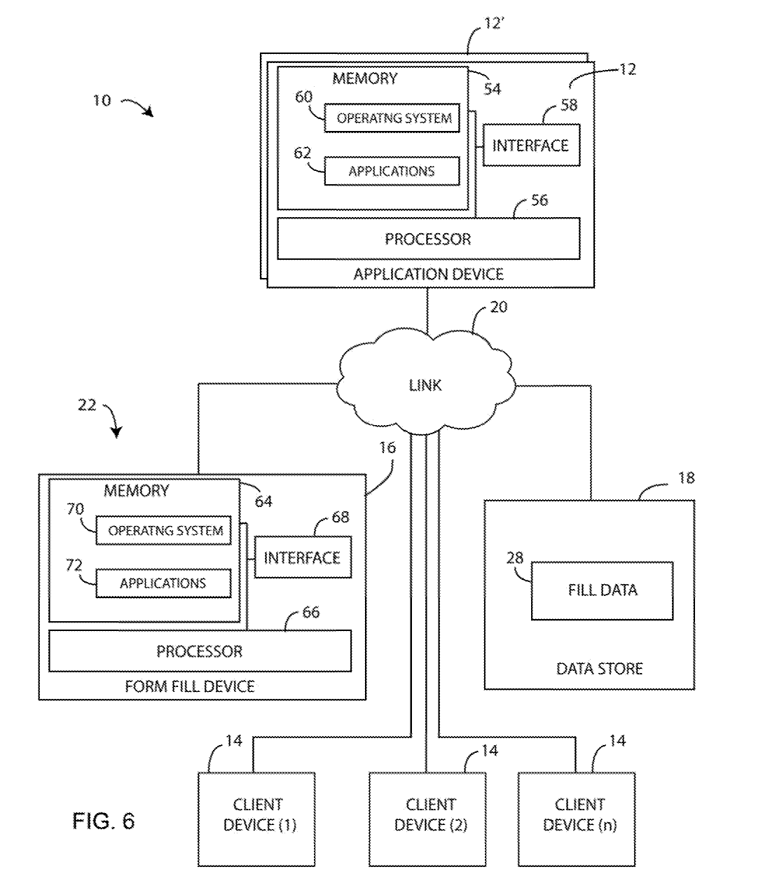

As a further example, FIG. 6 depicts a block diagram of system 22 implemented by form fill device 16. In the example of FIG. 6, application device 12 is shown to include memory 54, processor 56, and interface 58. Processor 56 represents generally any processor configured to execute program instructions stored in memory 54 to perform various specified functions. Interface 58 represents generally any interface enabling application device 12 to communicate with client devices 14 and form fill device 16 via link 20.

Memory 54 is shown to include operating system 60 and applications 62. Operating system 60 represents a collection of programs that when executed by processor 56 serve as a platform on which applications 62 can run. Examples of operating systems include, but are not limited, to various versions of Microsoft's Windows® and Linux®. Applications 62 represent program instructions that when execute by processor 56 function as an application that serves forms to client devices 14. Applications 62, when executed, may also function as a service that uses data communicated from form fill device to dynamically populate those forms. In response to a request for a form by a client device 14, that service returns uses the data to dynamically populate the requested form and returns it to the requesting client device 14. That service may instead be supplied by a proxy 12′ as discussed earlier.

Form fill device 16 is shown to include memory 64, processor 66, and interface 68. Processor 66 represents generally any processor configured to execute program instructions stored in memory 64 to perform various specified functions. Interface 68 represents generally any interface enabling form fill device 16 to communicate with application device 12 or proxy 12′.

Memory 64 is shown to include operating system 70 and applications 72. Operating system 70 represents a collection of programs that when executed by processor 66 serve as a platform on which applications 72 can run. Examples of operating systems include, but are not limited, to various versions of Microsoft's Windows® and Linux®. Applications 72 represent program instructions that when execute by processor 66 implement system 22 for identity based automated form filling as discussed above with respect to FIG. 2.

Looking at FIG. 2, association engine 24 and fill engine 26 are described a combinations of hardware and programming. The hardware portions may, depending on the embodiment, be implemented as processor 66. The programming portions, depending on the embodiment, can be implemented by operating system 70, applications 72, or combinations thereof.

### Operation

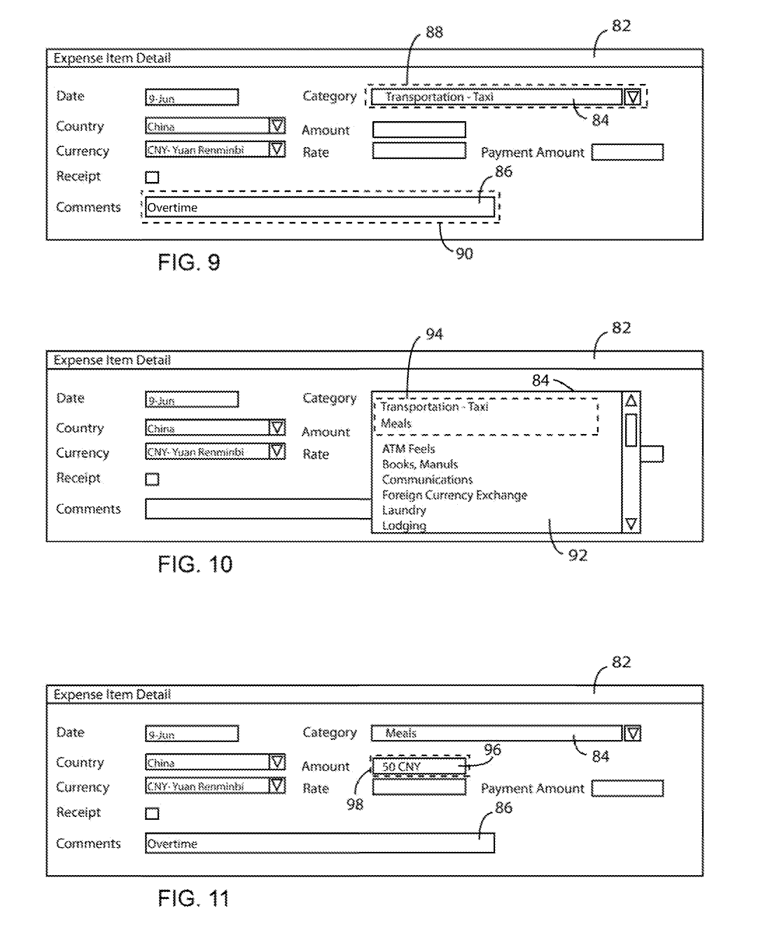

FIGS. 7 and 8 are exemplary flow diagrams of steps taken to implement embodiments of an identity based automated form filling method. In discussing FIGS. 7 and 8, reference is made to the diagrams of FIGS. 1-6 to provide contextual examples. Implementation, however, is not limited to those examples. Reference is also made to the example forms depicted in FIGS. 9-11. Again, such references are made simply to provide contextual examples.

Starting with FIG. 7, an association of a user, a form, and a plurality of values recorded over time for a plurality of fields of the form is maintained (step 74). Referring to FIG. 2, association engine 22 may be responsible for implementing step 74. Step 74 may include storing for each of a plurality of fields of the form, values selected by the user for that field over repeated submissions of the form by the user. The stored values are associated with the user and the form. FIG. 3 depicts examples of a table 32 that may be used in step 74 to maintain such an association. Step 74 may also include maintaining such associations for multiple users and multiple forms. For example, step 74 may include maintaining a first association of a first user, a form, and a first plurality of values recorded over time for the plurality of fields of the form—as well as—maintaining a second association of a second user, the form, and a second plurality of values recorded over time for the plurality of fields of the form.

Continuing with FIG. 7, the form is caused to be dynamically populated according to the association of step 74 following a request for the form by the user (step 76). Referring to FIG. 2, fill engine 26 may be responsible for implementing step 76. Step 76 can include causing a field of the plurality of fields of the form to be prefilled with one of the plurality of values that had been selected by the user to fill that field in a prior submission of the form. Looking ahead to FIG. 9, an example form 82 includes fields 84 and 86 that have been prefilled in this fashion. In the example of FIG. 9, form 82 is used in expense reporting. The particular user in question when submitting the form in the past had more often than not selected taxi for an expense category field 84 and overtime for a comments field 86,

Step 76 can include causing a field of the plurality of fields to be prefilled with recommendations including one or more of the plurality of values that had been selected by the user to fill that field in a prior submission of the form. Looking ahead to FIG. 10, example form 82 includes field 84 that have been prefilled in this fashion. In the example of FIG. 10, form 82 is used in expense reporting. The particular user in question when submitting the form in the past had more often than not selected taxi or meals for an expense category field 84. In FIG. 10, those two values are suggested to the user for use in populating field 84.

Also, step 76 can include, upon the user's selection of a first value for a first field in the form, causing a second field of the form to be filled with a second value or filled with a recommendation of the second value. Looking ahead to FIG. 11, example form 82 includes first or source field 84 and a second or target field 96. In the example of FIG. 11, form 82 is used in expense reporting. The particular user in question when submitting the form in the past when selecting meals as a value for field 84 had more often than not selected the value 50 CNY an amount for field 96. So as a result of the user selecting meals in field 84, field 96 has been automatically populated with the value 50 CNY.

Step 76 can also include causing a field in the form to be dynamically populated according to the association such that the field includes a pre-population indicator when the form is displayed to the user. Such an indicator is any discernable visual indicator drawing the user's attention to the fact that the given field has been dynamically populated in step 76. In the examples of FIG. 9-11, pre-population indicators take the form of dashed boundary lines 88, 90, 94, and 98 positioned proximate to the respective fields.

As noted above, step 74 can include maintaining a first association of a first user and a form and a second association of a second user and the form. In such a case, step 76 can include causing the form to be dynamically populated according to the first association following a request for the form by the first user and causing the form to be dynamically populated according to the second association following a request for he form by the second user.

FIG. 8 depicts an example of sub-steps that can be taken to implement step 76 of FIG. 7. To start, the association maintained in step 74 is employed to define a pre-fill model (step 78). That pre-fill model is configuration data that can be used to dynamically populate the form following a request for the form by the user. A pre-fill model is associated with one user and one form. Step 78 can include creation of the model, accessing a previously created model, and updating an existing model. Referring to FIG. 4, data 38 includes a pre-fill model 39 associated with form(n) and user(x). Continuing with FIG. 8, the pre-fill model defined in step 78 is communicated to a service acting in response to a request from the user for the form (step 80). As noted that service may be a service provided by an application that serves the form or a proxy.

As noted above step 74 of FIG. 7 can include maintaining a first association of a first user and a form and a second association of a second user and the form. In such a case, step 78 of FIG. 8 can include utilizing the first association to define a first pre-fill model and utilizing the second configured to define a second pre-fill model Step 80 would then include communicating the first pre-fill model to a service acting in response to a request from the first user for the form and communicating the second pre-fill model to a service acting in response to a request from the first user for the form.

### Conclusion

FIGS. 1-6 aid in depicting the architecture, functionality, and operation of various embodiments. In particular, FIGS. 2-6 depict various physical and logical components. Various components illustrated in FIG. 2-6 are defined at least in part as programs, programming, or program instructions. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 7-8 shows specific orders of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. An identity based automated form filling method, comprising:
maintaining an association of a user, a form, and a plurality of values recorded over time for a plurality of fields of the form; and
causing the form to be dynamically populated according to the association following a request for the form by the user.

2. The method of claim 1 wherein causing comprises:
employing the association to define a pre-fill model configured to be used to dynamically populate the form following a request for the form by the user; and
communicating the pre-fill model to a service acting in response to a request from the user for the form.

3. The method of claim 2, wherein the pre-fill model identifies one or more of:
a pre-fill candidate for one of the plurality of fields of the form;
one or more candidate values for one of the plurality of fields of the form, the one or more candidate values being ordered according to the association;
linked fields including a source field with an associated value and a target field with an associated second value.

4. The method of claim 1, wherein causing comprises one of:
causing a field of the plurality of fields of the form to be prefilled with one of the plurality of values that had been selected by the user to fill that field in a prior submission of the form;
causing a field of the plurality of fields to be prefilled with recommendations including one or more of the plurality of values that had been selected by the user to fill that field in a prior submission of the form; and
upon the user's selection of a first value for a first field, causing a second field of the form to be filled with a second value or filled with a recommendation of the second value.

5. The method of claim 1, wherein causing comprises causing a field in the form to be dynamically populated according to the association such that the field includes a pre-population indicator when the form is displayed to the user.

6. The method of claim 1, wherein maintaining an association comprises storing for each of a plurality of fields of the form, values selected by the user for that field over repeated submissions of the form by the user, the stored values associated with the user and the form.

7. The method of claim 1, wherein:
maintaining comprises maintaining a first association of a first user, the form, and a first plurality of values recorded over time for the plurality of fields of the form, and maintaining comprises maintaining a second association of a second user, the form, and a second plurality of values recorded over time for the plurality of fields of the form; and
causing comprises:
utilizing the first association to define a first pre-fill model
utilizing the second association to define a second pre-fill model;
communicating the first pre-fill model to a service acting in response to a request from the first user for the form; and
communicating the second pre-fill model to a service acting in response to a request from the second user for the form.

8. A computer readable medium having instructions that when executed implement a method for identity based automated form filling, the method comprising:
maintaining an association of a user, a form, and a plurality of values recorded over time for a plurality of fields of the form; and
causing the form to be dynamically populated according to the association following a request for the form by the user.

9. The medium of claim 8, wherein causing comprises:
employing the association to define a pre-fill model configured to be utilized to dynamically populate the form following a request for the form by the user; and
communicating the pre-fill model to a service acting in response to a request from the user for the form.

10. The medium of claim 9, wherein the pre-fill model identifies one or more of:
a pre-fill candidate for one of the plurality of fields of the form;
one or more candidate values for one of the plurality of fields of the form, the one or more candidate values being ordered according to the association;
linked fields including a source field with an associated first value and a target field with an associated second value.

11. The medium of claim 8, wherein causing one of:
causing a field of the plurality of fields of the form to be prefilled with one of the plurality of values that had been selected by the user to fill that field in a prior submission of the form;
causing a field of the plurality of fields to be prefilled with recommendations including one or more of the plurality of values that had been selected by the user to fill that field in a prior submission of the form; and
upon the user's selection of a first value for a first field, causing a second field of the form to be filled with a second value or filled with a recommendation of the second value.

12. The medium of claim 8, wherein causing comprises causing a field in the form to be dynamically populated according to the association such that the field includes a pre-population indicator when the form is displayed to the user.

13. The medium of claim 8, wherein maintaining an association comprises recording for each of a plurality of fields of the form, values selected by the user for that field over repeated submissions of the form by the user, the stored values associated with the user and the form.

14. The medium of claim 8 wherein:
maintaining comprises maintaining a first association of a first user, the form, and a first plurality of values recorded over time for the plurality of fields of the form, and maintaining a second association of a second user, the form, and a second plurality of values recorded over time for the plurality of fields of the form; and
causing comprises:
utilizing the first association to define a first pre-fill model
utilizing the second association to define a second pre-fill model;
communicating the first pre-fill model to a service acting in response to a request from the first user for the form; and
communicating the second pre-fill model to a service acting in response to a request from the second user for the form.

15. A system for identity based automated form filling, the system comprising an association engine and a fill engine, wherein:
the association engine is configured to maintain an association of a user, a form, and a plurality of values recorded over time for a plurality of fields of the form; and
the fill engine is configured to cause the form to be dynamically populated according to the association following a request for the form by the user.

16. The system of claim 15, wherein the fill engine is configured to:
employ the association to define a pre-fill model configured to be utilized to dynamically populate the form following a request for the form by the user; and
communicate the pre-fill model to a service acting in response to a request from the user for the form.

17. The system of claim 16, wherein the pre-fill model identifies one or more of:
a pre-fill candidate for one of the plurality of fields of the form;
one or more candidate values for one of the plurality of fields of the form, the one or more candidate values being ordered according to the association;
linked fields including a source field with an associated first value and a target field associated with a second value.

18. The system of claim 17, wherein the fill engine is configured to communicate the pre-fill model to cause the service to dynamically populate the form by one or more of:
pre-filling a field of the plurality of fields of the form with one of the plurality of values that had been selected by the user to fill that field in a prior submission of the form;
pre-filling a field of the plurality of fields with recommendations including one or more of the plurality of values that had been selected by the user to fill that field in a prior submission of the form; and
upon the user's selection of a first value for the source field, filling a target field of the form with the second value or filling the target field with a recommendation of the second value.

19. The system of claim 15, wherein the association engine is configured to maintain by recording, for each of a plurality of fields of the form, values selected by the user for that field over repeated submissions of the form by the user, the stored values associated with the user and the form.

20. The system of claim 15, wherein:
the association engine is configured to maintain a first association of a first user, the form, and a first plurality of values recorded over time for the plurality of fields of the form, and maintain a second association of a second user, the form, and a second plurality of values recorded over time for the plurality of fields of the form; and
the fill engine is configured to:
utilize the first association to define a first pre-fill model
utilize the second association to define a second pre-fill model;
communicate the first pre-fill model to a service acting in response to a request from the first user for the form; and
communicate the second pre-fill model to a service acting in response to a request from the second user for the form.
